(19) United States
(12) Patent Application Publication
(10) Pub. No.: US 2005/0190011 A1
(43) Pub. Date: Sep. 1, 2005

(54) Apparatus, system and method incorpating a power sampling circuit

(76) Inventors: James Andrew Martin III, Londonderry, NH (US); Simon Donald Richard Gay, Medford, MA (US); James Greaves Oakes, Sudbury, MA (US)

Correspondence Address: James S. Finn;c/o William Tucker, Box #8, 14431 Goliad Dr., Malakoff, TX, 75148, US

(21) Appl. No.: 11/014,161

(22) Filed: Dec. 15, 2004

Related U.S. Application Data
(60) Provisional application No. 60/529,570, filed on Dec. 15, 2003.

(51) Int. Cl. H01P 5/18

(52) U.S. Cl. 333/112

(57) ABSTRACT

An embodiment of the present invention provides a method of directional coupling, comprising utilizing the phase shift inherent in existing networks within an RF circuit to be monitored; and associating a plurality of capacitors and at least one termination resister with said RF circuit to enable said directional coupling. The plurality of capacitors may be three and said at least one termination resister may be one. In an embodiment of the present invention the RF circuit may be an impedance matching network or a filter.

### CROSS-REFERENCE TO RELATED APPLICATIONS

This application claims the benefit of provisional patent application No. 60/529,570, filed Dec. 15, 2004, by James Martin III et al.

### BACKGROUND OF THE INVENTION

RF sampling may be required in many applications for feedback to control circuitry. For example, and not by way of limitation, power amplifier modules (PAM's) may utilize RF sampling using: coupled parallel line directional couplers; lumped element directional couplers; or capacitive or resistive taps. However, there are many shortcomings to these apparatus and methods.

Thus, a strong need exists for an improved apparatus, system and method which may incorporate a power sampling circuit with improved directional coupling.

### SUMMARY OF THE INVENTION

An embodiment of the present invention provides a method of directional coupling, comprising utilizing the phase shift inherent in existing networks within an RF circuit to be monitored; and associating a plurality of capacitors and at least one termination resister with said RF circuit to enable said directional coupling. The plurality of capacitors may be three and said at least one termination resister may be one. In an embodiment of the present invention the RF circuit may be an impedance matching network or a filter.

The present invention may further provide an apparatus capable of enabling directional coupling, comprising an RF circuit, the RF circuit including an inherent phase shift; and a plurality of capacitors and at least one resister connected to the RF circuit so as to enable directional coupling. In an embodiment of the present invention the apparatus may be a power amplifier and the plurality of capacitors may be three and the at least one termination resister may be one and the RF circuit may be an impedance matching network or a filter. Further, the apparatus may further comprise additional components added to the network thereby enabling improved bandwidth and optimizing phase shifts for maximum directivity and enabling the capability to adjust the coupled power level and enabling the capability to compensate for parasitics.

Another embodiment of the present invention further provides an RF sampling method, comprising incorporating directional coupling with an apparatus to be sampled, the directional coupling utilizes the phase shift inherent in existing networks within an RF circuit to be monitored and associates a plurality of capacitors and at least one termination resister with the RF circuit to enable the directional coupling.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates the directional coupling of one embodiment of the present invention which utilizes the phase shift in an existing matching network;

FIG. 2 shows a sampled power level through a simple capacitive tap with no directivity showing very poor accuracy of only ±6 dB; and

FIG. 3 shows a sampled power level through new directional coupling circuit showing dramatically improved accuracy of ±1.25 dB in one embodiment of the present invention.

### DESCRIPTION OF THE PREFERRED EMBODIMENT

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Edge coupled parallel line directional couplers offer the benefit of high directivity which is important in separating the incident power to be measured from any reflected power. However, they are usually implemented using quarter wave length transmission lines. These lines can be excessively long in comparison the space available in an integrated circuit or module. What is more, the length of line can create undesirable attenuation of the RF signal to be sampled. In the example of a power amplifier module, a coupler would be placed on the output of the device after the output matching network. Good quality couplers in the frequency bands of interest for mobile communication applications can have up to 0.50 dB of loss. This loss can severely diminish the overall efficiency of the power amplifier module, thereby reducing talk time per battery charge.

Lumped element directional couplers have similar size and loss issues as the coupled parallel line format. The inductive and capacitive elements required often outstrip the available space, and the losses are easily higher than those for coupled parallel lines.

Resistive or capacitive taps provide low insertion loss, small size, and simplicity of integration. However, they offer no directivity. This leads to errors under high VSWR (voltage standing wave ratio) conditions on the output when reflected power is sampled along with the transmitted power.

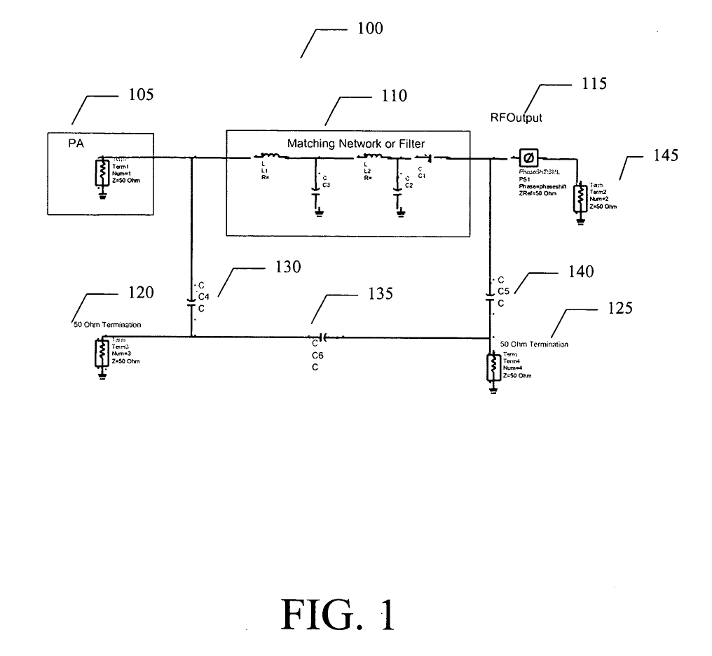

An embodiment of the present invention utilizes the benefits of low insertion loss, small size, and ease of integration provided by capacitive taps while adding the critical directivity necessary to isolate the measured incident power from VSWR effects on the output. In one embodiment it does so by utilizing the phase shift inherent in existing networks within the RF circuit to be monitored such as impedance matching networks or filters. By using the circuitry already required for ordinary circuit operation, this coupler scheme is capable of directional power sampling with negligible additional power loss. Turning now to FIG. 1, shown generally at 100, illustrates the directional coupling of one embodiment of the present invention which utilizes the phase shift in an existing matching network. The additional components necessary to create the directional coupler network as shown in FIG. 1 may be a plurality, such as, in an embodiment of the present invention, three, small capacitors 130,135, and 140 and at least one termination resistor 120, 125 or 145. In the embodiment illustrated in FIG. 1 an apparatus, such as a power amplifier 105, may be connected to four legs of a coupler structure wherein one leg may actually be the existing matching network 110. Additional components may be added to this basic network to improve bandwidth, optimize phase shifts for maximum directivity, adjust the coupled power level, or compensate for parasitics. This approach imitates the function of a lumped element coupler, but with fewer components and lower loss on the main through path. The terminations required may be a resistor or another circuit. For example the sampled RF power may go into a control ASIC for a power control loop. Another circuit may be used on either or both locations depending on which direction it is desired to sense from.

In an embodiment of the present invention, the additional components for adjusting the phase shift to maximize directivity and improve bandwidth may include, but is not limited to, inductors, capacitors, and resistors connected in series with the primary coupler capacitors or shunt to ground. For example an inductor in series with a primary cap would adjust the phase on that leg.

The same types of additional components may control the coupled power level. For example, a capacitor or resistor in series with the primary coupling caps could decrease the coupled power, while an inductor in series could increase the coupling at a particular frequency.

Although not limited in this respect, an example of these components compensating for parasitics may be the use of shunt capacitors to create a filter out of a parasitic bond wire, increasing the bandwidth and coupling. Further, although not limited in this respect, these components may be created on an RFIC such as the PA die, or placed on a module substrate as lumped SMT's or distributed networks, or integrated into a substrate (such as LTCC). Interconnections could be bond wires, traces on a substrate, and/or solder connection, although they are not required to be.

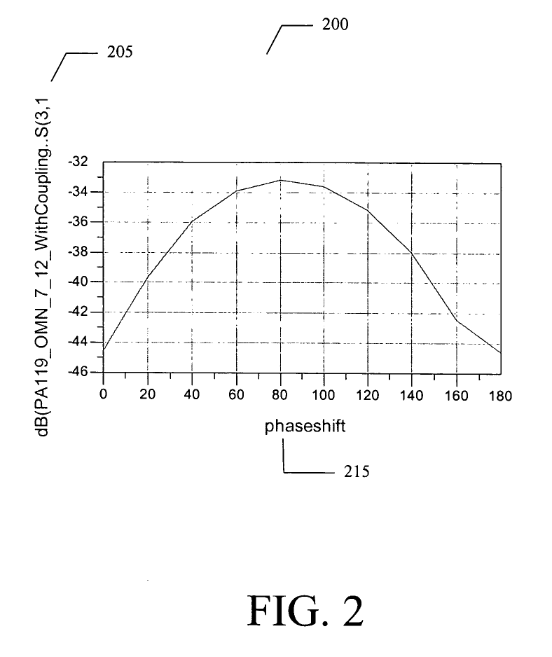

Turning now to FIG. 2 is illustrated a sampled power level through a simple capacitive tap with no directivity showing very poor accuracy of only ±6 dB. Simulations of an example of a circuit as it might be used in a GSM band power amplifier module are depicted. The circuit may be designed for small size, low insertion loss, and simplicity and may provide −33 dB of coupling from the input to the monitoring point, 13 dB of directivity, and extremely low additional loss on the main through path of only 0.03 dB. The directivity improves the accuracy of the sampled power level dramatically. The graph 200 of power level 205 vs. phaseshift 215 shows the variation in the measured power as the VSWR and phase of the output termination is varied to 6:1 and from 0 through 360 degrees, respectively for a simple capacitive tap with no directivity.

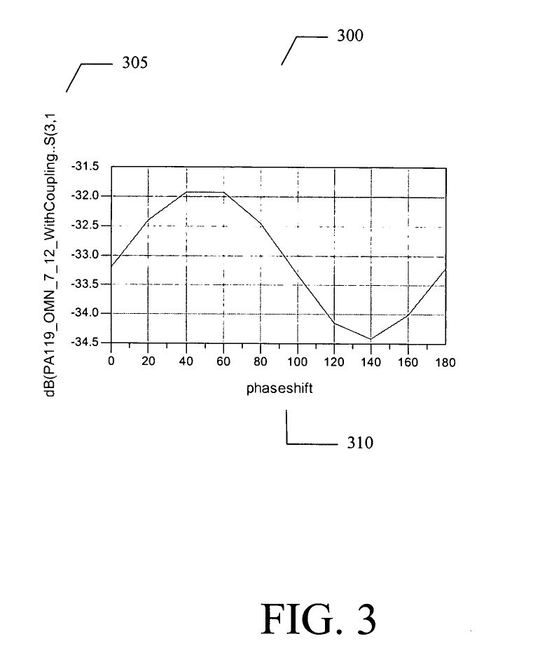

The graph, 300, of FIG. 3 demonstrates the significant improvement in accuracy of the sampled power level (shown as Y-axis 305) with the 13 dB of directivity created by the new coupling circuit. Phase shift 310 is illustrated on the X-axis. The accuracy of the measurement improves from a very poor ±6 dB to a improved ±1.25 dB. The more accurate sampling is adequate to provide power control for transmission of GSM type signals from a handset even under the conditions of a severe output mismatch.

The new circuit described herein provides all the benefits of good directional couplers for power sampling while offering several key benefits over existing techniques including extremely small size, simplicity, ease of integration into modules and IC's, tunability, and dramatically reduced insertion loss.

While the present invention has been described in terms of what are at present believed to be its preferred embodiments, those skilled in the art will recognize that various modifications to the disclose embodiments can be made without departing from the scope of the invention as defined by the following claims.

1. A method of directional coupling, comprising:
utilizing the phase shift inherent in existing networks within an RF circuit to be monitored; and
associating a plurality of capacitors and at least one termination resister with said RF circuit to enable said directional coupling.

2. The method of claim 1, wherein said plurality of capacitors is three and said at least one termination resister is one.

3. The method of claim 1, wherein said RF circuit is an impedance matching network.

4. The method of claim 1, wherein said RF circuit is a filter.

5. The method of claim 1, further comprising adding at least one inductor, at least one additional capacitor, or at least one resistor connected in series with a primary coupler capacitors, or shunt to ground, to said network, thereby enabling improved bandwidth and optimizing phase shifts for maximum directivity.

6. The method of claim 1, further comprising adding at least one inductor, at least one additional capacitor, or at least one resistor connected in series with a primary coupler capacitors, or shunt to ground, to said network to enable the capability to adjust the coupled power level.

7. The method of claim 1, further comprising adding at least one inductor, at least one additional capacitor, or at least one resistor connected in series with a primary coupler capacitors, or shunt to ground, to said network to enable the capability to compensate for parasitics.

8. An apparatus capable of enabling directional coupling, comprising:
an RF circuit, said RF circuit including an inherent phase shift; and
a plurality of capacitors and at least one resister connected to said RF circuit so as to enable directional coupling.

9. The apparatus of claim 8, wherein said apparatus is a power amplifier.

10. The apparatus of claim 8, wherein said plurality of capacitors is three and said at least one termination resister is one.

11. The apparatus of claim 8, wherein said RF circuit is an impedance matching network.

12. The apparatus of claim 8, wherein said RF circuit is a filter.

13. The apparatus of claim 8, further comprising at least one inductor, at least one additional capacitor, or at least one resistor connected in series with a primary coupler capacitors, or shunt to ground, to said network to enable enabling improved bandwidth and optimizing phase shifts for maximum directivity.

14. The apparatus of claim 8, further comprising at least one inductor, at least one additional capacitor, or at least one resistor connected in series with a primary coupler capacitors, or shunt to ground, to said network to enable the capability to adjust the coupled power level.

15. The apparatus of claim 8, further comprising at least one inductor, at least one additional capacitor, or at least one resistor connected in series with a primary coupler capacitors, or shunt to ground, to said network to enable enabling the capability to compensate for parasitics.

16. An RF sampling method, comprising:
incorporating directional coupling with an apparatus to be sampled, said directional coupling utilizes the phase shift inherent in existing networks within an RF circuit to be monitored and associates a plurality of capacitors and at least one termination resister with said RF circuit to enable said directional coupling;

17. The RF sampling method of claim 16, wherein said plurality of capacitors is three and said at least one termination resister is one.

18. The RF sampling method of claim 16, wherein said RF circuit is an impedance matching network.

19. The RF sampling method of claim 16, wherein said RF circuit is a filter.

20. The RF sampling method of claim 16, further comprising adding at least one inductor, at least one additional capacitor, or at least one resistor connected in series with a primary coupler capacitors, or shunt to ground, to said network to enable improved bandwidth and optimizing phase shifts for maximum directivity.

21. The RF sampling method of claim 16, further comprising adding at least one inductor, at least one additional capacitor, or at least one resistor connected in series with a primary coupler capacitors, or shunt to ground, to said network to enable the capability to adjust the coupled power level.

22. The RF sampling method of claim 16, further comprising adding at least one inductor, at least one additional capacitor, or at least one resistor connected in series with a primary coupler capacitors, or shunt to ground, to said network to enable the capability to compensate for parasitics.

23. The RF sampling method of claim 16, wherein said apparatus is a power amplifier.

24. The RF sampling method of claim 16, wherein said power amplifier is a component of a mobile communication device.
